(19) United States
(12) Patent Application Publication
(10) Pub. No.: US 2006/0235608 A1
(43) Pub. Date: Oct. 19, 2006

(54) Message integration method

(76) Inventor: Jien-Yang Chang, Taoyuan (TW)

Correspondence Address: RABIN & Berdo, PC, 1101 14TH STREET, NW, SUITE 500, WASHINGTON, DC, 20005, US

(21) Appl. No.: 11/403,834

(22) Filed: Apr. 14, 2006

(30) Foreign Application Priority Data
Apr. 15, 2005 (TW) 094112089

(51) Int. Cl. G08G 1/00

(52) U.S. Cl. 701/200; 701/213; 701/117

(57) ABSTRACT

A message integration method utilized in a satellite navigation device, which is used to integrate satellite positioning information and traffic condition information, thereby performing a real-time route-programming operation. Firstly, the satellite positioning information and the traffic condition information are received respectively. Next, the data format of the traffic condition information is converted into the same data format (for example, the NMEA message data format) as the satellite positioning information. Then, the traffic condition information is analyzed to obtain the route-programming parameters. And, the real-time route-programming operation is performed according to the route-programming parameters.

### CROSS-REFERENCE TO RELATED APPLICATIONS

This non-provisional application claims priority under 35 U.S.C. §119(a) on patent application No(s). 094112089 filed in Taiwan, R.O.C. on Apr. 15, 2005, the entire contents of which are hereby incorporated by reference.

### Field of the Invention

The invention relates to a message integration method, and more particularly, to a message integration method utilized in the satellite navigation device for integrating the satellite positioning information and the traffic condition information.

### Related Art

With the rapid development and progress of the information and the communication industries, the communication between people has become even more convenient, for instance, through the utilization of the various portable/mobile communication devices. The development and deployment of the Global Satellite Positioning System (GPS) has further raised the quality and precision of the communication. Presently, the satellite navigation device has gradually become one of the basic outfits of transportation means (for example, the vehicle). Through the navigation system of the satellite navigation device, the driver of the vehicle has only to input the position of his destination, then the route is programmed by the navigation system and is displayed by means of an electronic map in cooperation with the reminding voice message, to facilitate the implementation and utilization of the satellite navigation system by the driver of the vehicle.

However, presently, route programming is done by making use of the map stored in the memory in advance. Thus, in this fixed and static type route programming and guidance system, the route can not be adjusted dynamically according to the traffic condition. Therefore, the route actually taken must be adjusted by the driver of the vehicle himself based on the existing traffic condition of the route obtained through the broadcast of the traffic information broadcasting system. However, to the driver unfamiliar with the geographic environment of the related route, this would cause quite a lot of problems and confusions.

As such, the most urgent task in this field is the research and development of a method of integrating the satellite positioning information and the traffic condition information and providing it to the application software of the satellite navigation device for further processing, thus enabling the satellite navigation device to adjust the mobile route real-time according to the actual traffic condition of the route.

### SUMMARY OF THE INVENTION

In view of the above-mentioned problems and shortcomings of the prior art, an object of the invention is to provide a message integration method of a satellite navigation device, which can be used to in real-time perform a route-programming operation according to the corresponding route programming parameters obtained through analyzing the data in the traffic condition information, thereby adjusting the programmed mobile route according to the actual traffic conditions.

Therefore, to achieve the above-mentioned objective, the invention provides a message integration method, utilized in the satellite navigation device, for integrating the satellite positioning information and the traffic condition information, to execute the route-programming operation in real time, including the following steps.

Firstly, the satellite positioning information and the traffic condition information is received. For example, the satellite positioning information and the traffic condition information can be respectively acquired through a satellite positioning data receiver and a traffic message receiver (e.g. the Radio Data System (RDS) receiver and the Digital Audio Broadcast (DAB) receiver). Next, the data format of the traffic condition information is converted into the same format data format as the satellite positioning information. Then, the traffic condition information is analyzed to obtain the corresponding route-programming parameters. And, the route-programming operation is performed according to the route-programming parameters in real-time.

When the message integration method according to the invention is utilized in the satellite navigation device, the data format of the traffic condition information and that of the satellite positioning information are converted and integrated into the same data format, to be provided for the application program of the satellite navigation device to further process. Subsequently, the data in the traffic condition information is analyzed to obtain the corresponding route-programming parameters. And, the real-time route-programming operation is executed according to the corresponding route-programming parameters. Therefore, the programmed mobile route is adjusted according the actual traffic conditions.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, wherein:

FIG. 1 is a system block diagram of the satellite navigation device having a real-time route-programming capability according to an embodiment of the invention;

FIG. 2 is a schematic diagram of the integration of the satellite positioning information and the traffic condition information into the information of a new format; and

FIG. 3 is a flowchart of the steps of data integration according to the embodiment of the invention.

### DETAILED DESCRIPTION OF THE INVENTION

The purpose, construction, features, and functions of the invention can be appreciated and understood more thoroughly through the following detailed description with reference to the attached drawings.

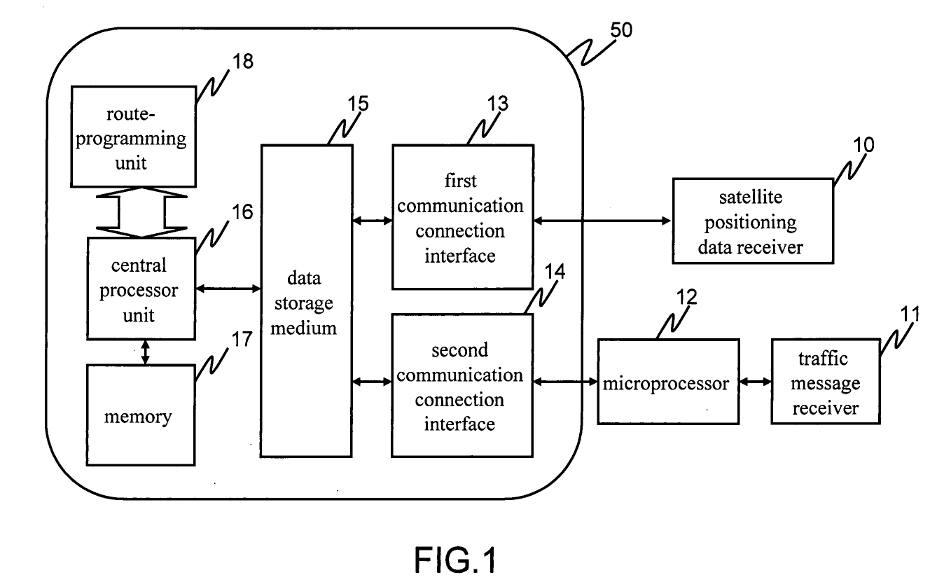

Please refer to FIG. 1 of a system block diagram of the satellite navigation device having a real-time route-programming capability according to an embodiment of the invention. The satellite navigation device includes a satellite positioning data receiver 10, a traffic message receiver 11, a microprocessor 12, and a satellite navigation module 50.

The satellite positioning data receiver 10 is utilized to provide satellite position information acquired from the satellite.

Such the satellite position information is acquired through converting satellite position signals corresponding to the present position of an apparatus, where the satellite navigation device is applied, and received from at least 3 satellites. The satellite positioning data receiver 10 can comprise an antenna (not shown) and a receiver circuit (not shown), wherein the receiver circuit is used to convert the satellite positioning signals to the satellite positioning information.

The traffic message receiver 11 is used to receive a traffic message signal transmitted from the Traffic Message Center (TMC). Herein, the traffic message receiver can include an antenna (not shown) and a receiver circuit (not shown). The traffic message receiver 11 can be of a Radio Data System (RDS) receiver or a Digital Audio Broadcast (DAB) receiver.

The microprocessor 12 is connected to the traffic message receiver 11 and is used to process the traffic message signal received by the traffic message receiver 11, and then perform the digitalized processing of the signal, so that the traffic message signal is converted to the traffic condition information.

The satellite navigation module 50 is used to process the information from the satellite positioning data receiver 10 and the traffic message receiver 11. That is, the satellite navigation module 50 can receive the satellite positioning information corresponding to the present position of the apparatus and the traffic condition information corresponding to the present traffic condition. On the basis of the information, the satellite navigation module 50 can program a mobile route and perform the navigation operation according to the programmed mobile route. Moreover, the satellite navigation module 50 can adjust and reprogram the programmed mobile route upon re-receiving the traffic condition information. By the mobile route is the shortest mobile route from the present position of the apparatus to its destination. The satellite navigation module 50 can include a first communication connection interface 13, a second communication connection interface 14, a data storage medium 15, a central processor unit 16, a memory 17, and a route-programming unit 18. The details of each of these devices are described as follows.

The first communication connection interface 13 is connected to the satellite positioning data receiver 10 and functions as a transmission interface for the data transmission channel, which has the capability of double direction data transmission. The first communication connection interface may be the communication connection port of the Universal Asynchronous Receiver Transmitter (UART) specification, the Universal Serial Bus (USB) specification, and the like.

The second communication connection interface 14 is connected to the microprocessor 12 and functions as the transmission interface for the data transmission channel, which has the capability of double direction data transmission. The second communication connection interface 14 may be the communication connection port of the Universal Asynchronous Receiver Transmitter (UART) specification, the Universal Serial Bus (USB) specification, and the like. Moreover, the traffic condition information is compatible with the data transmission format of the second communication connection interface 14.

Further, the microprocessor 12 is connected respectively to traffic message receiver 11 and the second communication connection interface 14, so that it can have fewer pins. Furthermore, it may only process the data (e.g. the traffic condition information) received from the traffic message receiver 11, so that a microprocessor with a simpler circuit construction and lower cost may be utilized.

The data storage medium 15 is connected respectively to the first communication connection interface 13 and the second communication connection interface 14, and has a pre-stored program of the Dynamic Link Library. In addition, it is provided with a storage area to store or temporarily store the satellite positioning information and the traffic condition information. The data storage medium 15 can be of a hard disk drive device or another hardware device, having a data storage capability.

The central processor unit 16 is connected to the data storage medium 15 and is the central core unit of the satellite navigation module 50. The central processor unit 16 is utilized to process the signal transmission of the various units and the procedures in relation to instruction calling, execution and operation, including the calling and executing of the DLL program codes of the data storage medium 15, thus integrating the traffic condition information and the satellite positioning information into the same data format (for example, an NMEA data format). The calling type of the DLL program can be classified into: Explicit Import, Implicit Import and Dynamical Import.

The memory 17 is connected to the central processor unit 16 to provide a storage area for storing temporarily the data waited to be processed by the central processor unit. The memory 17 can be of the synchronous dynamic random access memory (SDRAM) or the synchronous double data rate dynamic random access memory (DDR-DRAM).

The route-programming unit 18 is of a computer application program, and is used to execute the programmed mobile route navigation operation through the central processor unit 16, and on the basis of these information, to program and generate the optimal mobile route, depending on the actual traffic conditions by calculating the information corresponding to the actual traffic conditions from the traffic message receiver 11 through the central processor unit 16. In addition, the prompted information representing the existence of other mobile routes is displayed by a display device (not shown) for the user to select the mobile route.

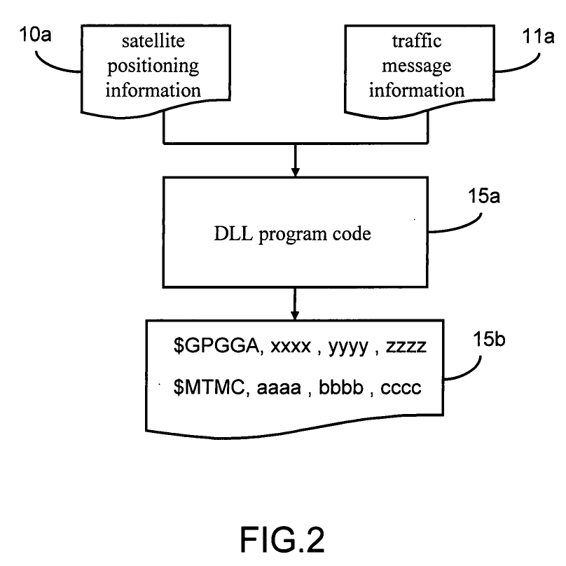

Please refer to FIG. 2 of a schematic diagram of the integration of the satellite positioning information and the traffic condition information. As shown in FIG. 2, the satellite positioning information 10a and the traffic condition information 11a are obtained through the satellite positioning data receiver 10, the traffic message receiver 11 and the microprocessor 12. Then they are converted into the National Marine Electronic Association (NMEA) message data format by making use of the DLL program 15a, stored in the data storage medium 15, thereby being provided for the route-programming unit 18 with the operation parameters required to execute the route-programming in real-time.

The data message in the NMEA format is transmitted in the form of sentences, e.g. a data format of ‘$GPGGA,xxxx,yyyy,zzzz” and’$MTMC,aaaa,bbbb,cccc”, as shown in block 15b. Each of the sentences starts with “$”, with each of its field separated by “,”, and the length of the sentence is variable and can reach 82 characters at most. Each of the sentences can be divided into three sections: the header section, the data section and the ending section containing the checksum code.

The traffic condition information and the satellite positioning information are identified and distinguished through their header sections, and then the specific data in the data section of the traffic condition information is obtained and utilized as the parameter to perform the real-time route-programming operation. The traffic condition information is converted to and integrated into the standard NMEA format, and further, is available for reading and processing by the route-programming unit 18 or other application programs.

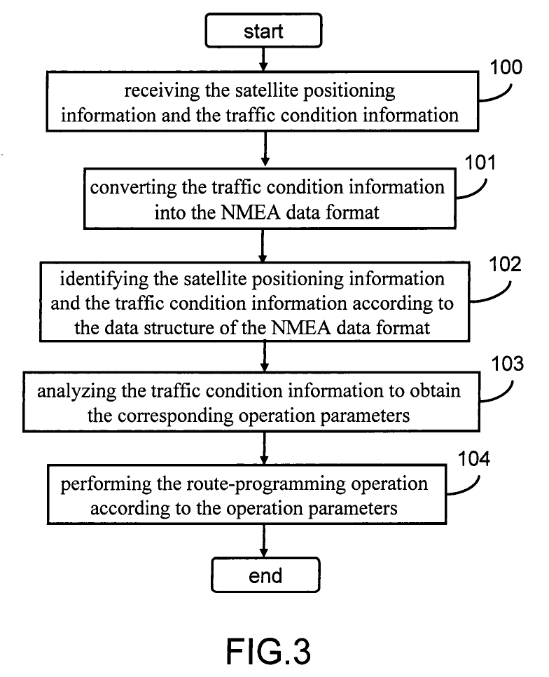

Please refer to FIG. 3 of a flow chart of the steps of message integration. Firstly, the satellite positioning information and the traffic condition information is provided (step 100). For example, the satellite positioning information and the traffic condition information can be respectively received through the satellite positioning data receiver 10 and the traffic message receiver 11. Next, the data format of the traffic condition information is converted into that of the National Maritime Electronic Association (NMEA), i.e. the converted data format is the same as that of the satellite positioning information (step 101). Then, the satellite positioning information and the traffic condition information is identified according to the contents of the data section of the data structure in the NMEA message data format, for example, the content of the header section of the satellite positioning information is “$GPGGA”, while the content of the header section of the traffic condition information is “$MTMC” (step 102).

Next, the traffic condition information is analyzed to obtain the corresponding route-programming parameters, namely, the traffic condition data in the data section of the traffic condition information is analyzed, thereby retrieving the traffic conditions (for example, congestion or smooth) related to the roads or streets in the programmed mobile route as the route-programming parameters (step 103).

Then, re-executing the route-programming operation according to the operation parameters just obtained, for example, the route-programming unit 18 is utilized to execute the real-time route-programming operation according to the satellite positioning information and the traffic condition information obtained (step 104).

In addition, the steps 101, 102, and 103 can be performed by the satellite navigation module 50, and are of the device as shown in FIG. 1, thus they will not be repeated here for brevity's sake.

When the message integration method according to the invention is utilized in the satellite navigation device, the data format of the traffic condition information and that of the satellite positioning information are converted to and integrated into the same data format, to be provided for the application program of the satellite navigation device for further processing. Subsequently, the data in the traffic condition information is analyzed to obtain the corresponding route-programming parameters. Then, the real-time route-programming operation is executed according to the corresponding route-programming parameters. Therefore, the programmed mobile route is adjusted according the actual traffic conditions.

Knowing the invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A message integration method utilized in a satellite navigation device for performing a real-time route-programming operation, comprising the following steps:
receiving a satellite positioning information and a traffic condition information;
converting a data format of the traffic condition information into the same data format of the satellite positioning information;
analyzing the traffic condition information to obtain at least one route-programming parameter: and
performing a real-time route-programming operation according to the route-programming parameters.

2. The message integration method as claimed in claim 1, wherein the data format is the National Maritime Electronic Association (NMEA) message data format.

3. The message integration method as claimed in claim 1, wherein the data format comprises a header section, a data section, and an ending section.

4. The message integration method as claimed in claim 3, wherein after the step of converting a data format of the traffic condition information into the same data format of the satellite positioning information, the message integration method further comprising a step of:
identifying and distinguishing the satellite positioning information and the traffic condition information according to a data section of the data format.

5. The message integration method as claimed in claim 1, wherein the steps of converting a data format of the traffic condition information into the same data format of the satellite positioning information, analyzing the traffic condition information to obtain one or more route-programming parameters, and performing the real-time route-programming operation according to the route-programming parameters are performed by a satellite navigation module of the satellite navigation device.

6. The message integration method as claimed in claim 5, wherein the satellite navigation module comprises:
a first communication connection interface functioning as a data transmission channel interface for transmitting the satellite positioning information;
a second communication connection interface functioning as a data transmission channel interface for transmitting the traffic condition information;
a data storage medium for storing the satellite positioning information and the traffic condition information;
a central processor unit for processing the satellite positioning information and the traffic condition information;
a memory for storing temporarily the data waited to be processed by the central processor unit; and
a route-programming unit, executed by the central processor unit, for performing the real-time route-programming operation.

7. The message integration method as claimed in claim 6, wherein the data storage medium has a pre-stored program of a Dynamic Link Library (DDL) for being called and executed by the central processor unit to convert the data format of the satellite positioning information into the same data format as the traffic condition information.

8. The message integration method as claimed in claim 6, wherein the first communication connection interface is a Universal Asynchronous Receiver Transmitter (UART) connection port.

9. The message integration method as claimed in claim 6, wherein the first communication connection interface is a universal serial bus (USB) connection port.

10. The message integration method as claimed in claim 6, wherein the second communication connection interface is a Universal Asynchronous Receiver Transmitter (UART) connection port.

11. The message integration method as claimed in claim 6, wherein the second communication connection interface is a universal serial bus (USB) connection port.

12. The message integration method as claimed in claim 1, wherein the traffic message receiver comprises a Radio Data System (RDS) receiver.

13. The message integration method as claimed in claim 1, wherein the traffic message receiver comprises a Digital Audio Broadcast (DAB) receiver.
